(19) United States
(12) Patent Application Publication
(10) Pub. No.: US 2009/0086736 A1
(43) Pub. Date: Apr. 2, 2009

(54) NOTIFICATION OF OUT OF ORDER PACKETS

(76) Inventors: Annie Foong, Aloha, OR (US); Bryan E. Veal, Hillsboro, OR (US)

Correspondence Address: Caven & Aghevli LLC;c/o CPA Global, P.O. BOX 52050, MINNEAPOLIS, MN, 55402, US

(21) Appl. No.: 11/864,276

(22) Filed: Sep. 28, 2007

(51) Int. Cl. H04L 12/56

(52) U.S. Cl. 370/394

(57) ABSTRACT

Methods and apparatus relating to notification of out-of-order packets are described. In an embodiment, data such as a sequence number and a flow identifier may be extracted from a packet. The extracted data may be used to check the extracted sequence number against an expected sequence number and indicate that the packet is an out-of-order packet. Other embodiments are also disclosed.

### BACKGROUND

The present disclosure generally relates to the field of electronics. More particularly, an embodiment of the invention generally relates to notification of out-of-order packets.

Networking has become an integral part of computing. The network software of end-systems (such as clients and servers) generally operates more efficiently when packets are processed in the order transmitted. Out-of-order packets may be caused by the network (which is beyond the control of an individual system) and implementation artifacts within end-systems. With the increase in the number of processor cores on end-systems, more implementation artifacts may occur which in turn could cause additional out-of-order packet processing.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures may indicate similar items.

FIG. 1 illustrates various components of an embodiment of a networking environment, which may be utilized to implement various embodiments discussed herein.

FIGS. 2 and 4 illustrate block diagrams of embodiments of computing systems, which may be utilized to implement some embodiments discussed herein.

FIG. 3 illustrates a flow diagram in accordance with an embodiment of invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Generally, out-of-order (also referred to as “OOO”) packets may pose a relatively large performance penalty on the throughput of a network flow processing (such as TCP (Transmission Control Protocol) processing). For example, TCP may interpret OOO packets as packet loss and may ultimately induce congestion control. As a result, transmission rate may be reduced (e.g., by half in some implementations) per the congestion control event. OOO packet processing is also generally considered an exception, and the presence of an OOO packet can induce the slow path (versus the highly optimized fast path).

In some implementations, a single processing core may have the ability to maintain the maximum throughput of a single network flow. Therefore, in-order packet processing within such systems may be achieved relatively easily. For example, in-order processing may be achieved by ensuring that all packets belonging to the same flow are processed by a single processing core. In some embodiments, as network bandwidth per flow increases, multiple cores may be used to process packets from a single flow (which may be referred to as “intra-flow parallelism”). Since in such embodiments packets are sent to different cores, the packets may be processed out-of-order, even if they arrive in order into the system. For example, packets 1-400 may arrive in order from the network and packets 1-200 may be assigned to core 1 while packets 201-400 may be assigned to core 2. However, the system may process packet 201 immediately after packet 1, thereby creating an OOO processing situation. In some implementations, out-of-order delivery may occur due to multiple cores working on the same flow.

To this end, some embodiments discussed herein may allow a network adapter (such as a network interface controller or card (NIC)) to provide sequencing information to the processor cores of a computing system (such as an end-system that receives data from a network). This may in turn eliminate or reduce the number of out-of-order packets (e.g., generated due to implementation artifacts). In one embodiment, packets of the same flow may be concurrently processed by more than one processor core based on sequencing information provided by a network adapter.

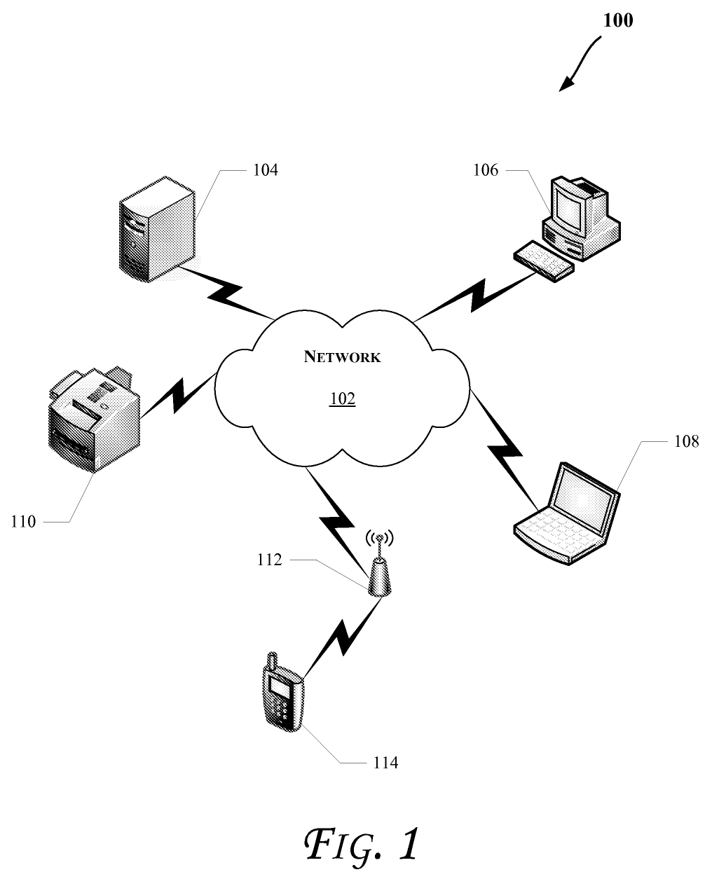

FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112, a personal digital assistant or smart phone 114, a rack-mounted computing system (not shown), etc. The network 102 may be any type of a computer network including an intranet, the Internet, and/or combinations thereof.

The devices 104-114 may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any type of communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) or external network interface devices (e.g., having a separate physical enclosure and/or power supply than the computing system to which it is coupled) such as a network interface card or controller (NIC).

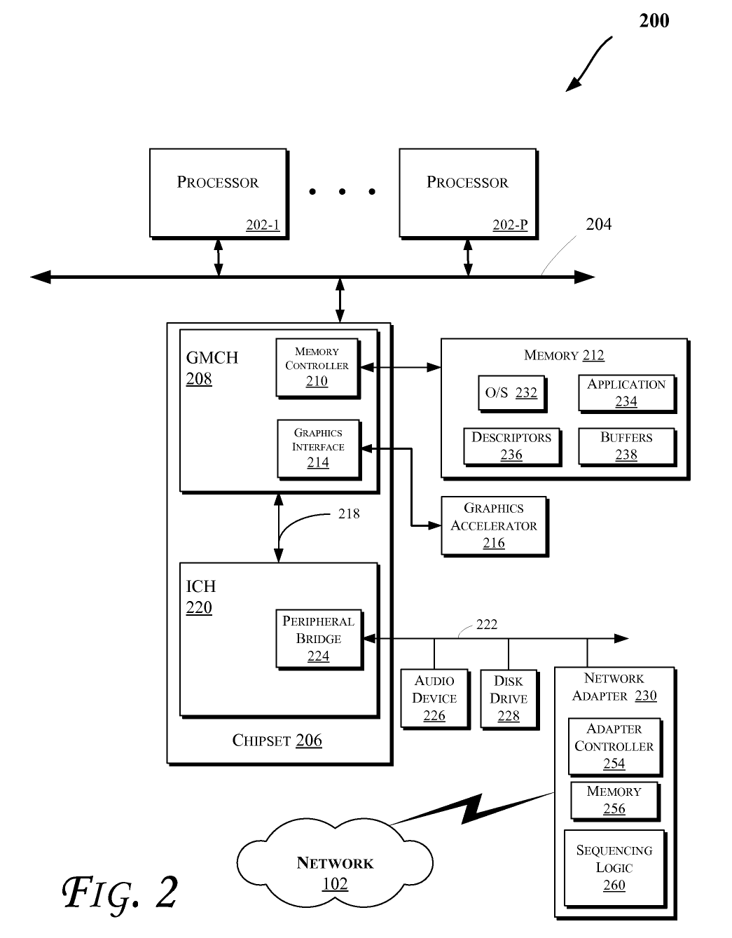

FIG. 2 illustrates a block diagram of a computing system 200 in accordance with an embodiment of the invention. The computing system 200 may include one or more central processing unit(s) (CPUs) or processors 202-1 through 202-P (which may be referred to herein as “processors 202” or “processor 202”). The processors 202 may communicate via an interconnection network (or bus) 204. The processors 202 may include a general purpose processor, a network processor (that processes data communicated over the computer network 102), or other types of a processor (including a reduced instruction set computer (RISC) processor or a complex instruction set computer (CISC)). Moreover, the processors 202 may have a single or multiple core design. The processors 202 with a multiple core design may integrate different types of processor cores on the same integrated circuit (IC) die. Also, the processors 202 with a multiple core design may be implemented as symmetrical or asymmetrical multiprocessors. In an embodiment, various operations discussed herein may be performed by one or more components of the system 200.

A chipset 206 may also communicate with the interconnection network 204. The chipset 206 may include a graphics memory control hub (GMCH) 208. The GMCH 208 may include a memory controller 210 that communicates with a main system memory 212. The memory 212 may store data, including sequences of instructions that are executed by the processor 202, or any other device included in the computing system 200. In one embodiment of the invention, the memory 212 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 204, such as multiple CPUs and/or multiple system memories.

The GMCH 208 may also include a graphics interface 214 that communicates with a graphics accelerator 216. In one embodiment of the invention, the graphics interface 214 may communicate with the graphics accelerator 216 via an accelerated graphics port (AGP). In an embodiment of the invention, a display (such as a flat panel display, a cathode ray tube (CRT), a projection screen, etc.) may communicate with the graphics interface 214 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 218 may allow the GMCH 208 and an input/output control hub (ICH) 220 to communicate. The ICH 220 may provide an interface to I/O devices that communicate with the computing system 200. The ICH 220 may communicate with a bus 222 through a peripheral bridge (or controller) 224, such as a peripheral component interconnect (PCI) bridge, a universal serial bus (USB) controller, or other types of peripheral bridges or controllers. The bridge 224 may provide a data path between the processor 202 and peripheral devices. Other types of topologies may be utilized. Also, multiple buses may communicate with the ICH 220, e.g., through multiple bridges or controllers. Moreover, other peripherals in communication with the ICH 220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 222 may communicate with an audio device 226, one or more disk drive(s) 228, and one or more network interface device(s) 230 (which is in communication with the computer network 102 and may comply with one or more of the various types of communication protocols discussed with reference to FIG. 1). In an embodiment, the network interface device 230 may be a NIC. Other devices may communicate via the bus 222. Also, various components (such as the network interface device 230) may communicate with the GMCH 208 in some embodiments of the invention. In addition, the processor 202 and the GMCH 208 may be combined to form a single chip. Furthermore, the graphics accelerator 216 may be included within the GMCH 208 in other embodiments of the invention.

Furthermore, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 200 may be arranged in a point-to-point (PtP) configuration. For example, processors, memory, and/or input/output devices may be interconnected by a number of point-to-point interfaces.

As illustrated in FIG. 2, the memory 212 may include one or more of an operating system(s) (O/S) 232 or application(s) 234. The memory 212 may also store one or more device driver(s), packet buffers 238, descriptors 236 (which may point to the buffers 238 in some embodiments), network protocol stack(s), etc. to facilitate communication over the network 102. Programs and/or data in the memory 212 may be swapped into the disk drive 228 as part of memory management operations. The application(s) 234 may execute (on the processor(s) 202) to communicate one or more packets with one or more computing devices coupled to the network 102 (such as the devices 104-114 of FIG. 1). In an embodiment, a packet may be a sequence of one or more symbols and/or values that may be encoded by one or more electrical signals transmitted from at least one sender to at least on receiver (e.g., over a network such as the network 102). For example, each packet may include a header that includes various information, which may be utilized in routing and/or processing the packet, such as a source address, a destination address, packet type, etc. Each packet may also have a payload that includes the raw data (or content) the packet is transferring between various computing devices (e.g., the devices 104-114 of FIG. 1) over a computer network (such as the network 102).

In an embodiment, the application 234 may utilize the O/S 232 to communicate with various components of the system 200, e.g., through a device driver (not shown). Hence, the device driver may include network adapter 230 specific commands to provide a communication interface between the O/S 232 and the network adapter 230. Furthermore, in some embodiments, the network adapter 230 may include a (network) protocol layer for implementing the physical communication layer to send and receive network packets to and from remote devices over the network 102. The network 102 may include any type of computer network such as those discussed with reference to FIG. 1. The network adapter 230 may further include a DMA (direct memory access) engine, which may write packets to buffers 238 assigned to available descriptors 236 in the memory 212. Additionally, the network adapter 230 may include a network adapter controller 254, which may include hardware (e.g., logic circuitry) and/or a programmable processor (such as the processors 202) to perform adapter related operations. In an embodiment, the adapter controller 254 may be a MAC (media access control) component. The network adapter 230 may further include a memory 256, such as any type of volatile/nonvolatile memory, and may include one or more cache(s).

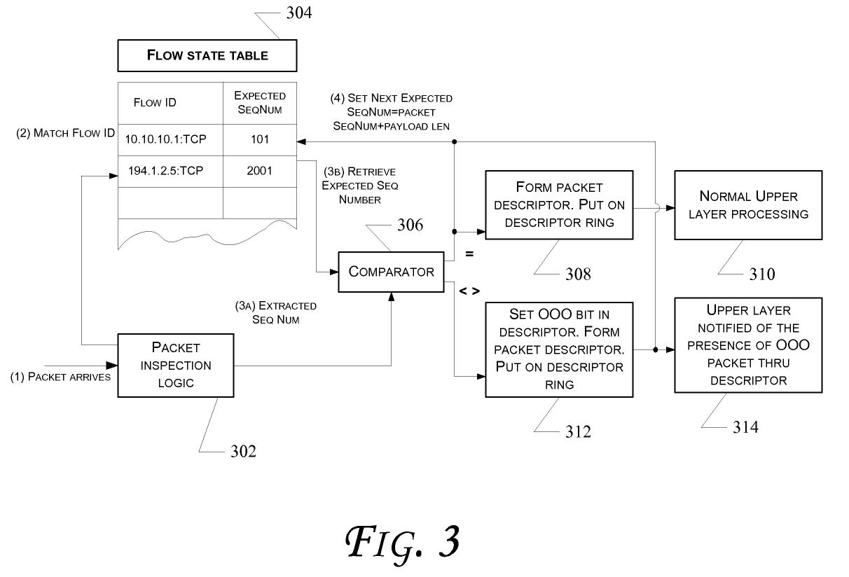

As shown in FIG. 2, the network adapter 230 may include a sequencing logic 260 (which may be implemented as hardware, software, or some combination thereof) to assist in in-order processing of incoming packets from the network 102 as will be further discussed herein, e.g., with reference to FIG. 3. In one embodiment, logic 260 may be optional and the adapter controller 254 may perform operations discussed herein with reference to the logic 260, such as the operations discussed with reference to FIG. 3. Also, the controller 254 may perform such operations in accordance with instructions stored in a storage device (such as the memory 212 and/or memory 256) in some embodiments.

Furthermore, the controller 254, processor(s) 202, and/or logic 260 may have access to a cache (not shown). Moreover, the cache may be a shared or private cache, e.g., including various levels such as one or more of a level 1 (L1) cache, a level 2 (L2) cache, a mid-level cache (MLC), or a last level cache (LLC). In some embodiments, the cache may be incorporated on the same IC chip as the controller 254, processor(s) 202, and/or logic 260.

FIG. 3 illustrates a flow diagram of packets through various components of a computing system (such as the computing systems discussed herein, e.g., with reference to FIGS. 1-2 or 4), according to an embodiment. In some embodiments, one or more of the components discussed with reference to FIGS. 1-3 and/or 4 may be used to perform one or more of the operations discussed with reference to FIG. 3. Moreover, in one embodiment, logic 260 and/or the network adapter 230 of FIG. 2 may comprise one or more of the components discussed with reference to FIG. 3, including, for example, one or more of the items 302 through 306.

Referring to FIGS. 1-3, a packet inspection logic 302 may receive a packet from a network (e.g., network 102) at an operation (1). The logic 302 may inspect the received packet (e.g., the header of the received packet) for packet flow data (such as a flow identifier) and cause a check against entries of a flow state table 304 at an operation (2). The table 304 may be stored in any storage device discussed herein (such as the memory 256 and/or 212). In an embodiment, the flow identifier may include an address (such as a MAC address or an IP (Internet Protocol) address) and an indication of the protocol used to communicate the packet, such as TCP, etc. Even though some examples have been discussed with respect to TCP, or its varieties, such as TCP Reno, techniques discussed herein may be applied to other types of protocols for which packet order may affect performance, such as DCCP (Datagram Congestion Control Protocol), SCTP (Stream Control Transmission Protocol), and IPsec (Internet Protocol Security).

As illustrated in FIG. 3, the logic 302 may also inspect the received packet for a sequence number and forward the sequence number to a comparator 306 at (3A). For example, the logic 260 may read a known offset based on a specific supported protocol (e.g. for TCP, the sequence number is at byte 5 of the TCP header) at operation (3A). The comparator 306 may also receive an expected next sequence number (ESN) at (3B) for the particular flow based on the lookup of operation (2). To this end, in an embodiment, the table 304 may store at least two bytes for each entry (e.g., for TCP). Moreover, wrapped-around sequence numbers may occur every 2,941,758 (for full-sized 1460B packets) and wrap-around may be treated as an exception in some embodiments, e.g., at wrap-around, the network adapter 230 (or logic 260) may signal OOO, and the network stack may react accordingly. Furthermore, in an embodiment, for every flow, four bytes may be used to store the expected next sequence number, and twelve bytes for the unique identify of a TCP flow (5-tuple: source IP, source port, destination IP, destination port, protocol). With some current network adapter implementations, the storage requirement may be 2 K bytes for 128 flows. Hence, the memory on the network adapter 230 (e.g., memory 256) may be about 2 K bytes to support up to 128 large flows. Furthermore, for a coherent network adapter or a network adapter partially implemented using a processor (e.g., processor 202), host memory (e.g., memory 212) may be used by the network adapter 230 for this purpose. In one embodiment, the 5-tuple flow identifier may be used to look up the next expected sequence number (stored on the network adapter 230). Various speed optimizations (including using the Toeplitz hash adopted by Receive-side Scaling network adapters) for fast lookups may be utilized in some embodiments. In an embodiment, a hash with linear search on collision may be used.

The comparator 306 may compare the expected sequence number and the extracted sequence number and indicate whether the values are equal or different. If the values are equal, the next expected sequence number may be stored in the table 304. The stored value may be set to the combination of the packet sequence number and payload length at operation (4). As such, the logic 302 may also send the payload length along with the extracted sequence number at operation (3A) in an embodiment. At an operation 308, a packet descriptor may be formed and added to the descriptor ring (e.g., added to descriptors 236 of FIG. 2). At an operation 310, normal upper layer processing (e.g., by the network stack, the O/S 232, an application program, a protocol offload device that would offload processing from processors 202 (e.g., a TCP offload engine that would be provided in a NIC, etc.) may be performed.

Alternatively, if the comparator determines that the compared values are different, one or more bits denoting OOO packets in a corresponding descriptor may be modified (e.g., set or cleared depending on the implementation) and a packet descriptor may be formed and added to the descriptor ring (e.g., added to descriptors 236 of FIG. 2) at an operation 312. At an operation 314, the upper layer (e.g., network stack of the O/S 232) may be notified of the OOO packet presence through the descriptor formed at operation 312. For example, when the network adapter 230 detects an OOO packet, the bit discussed at operation 312 may be set in an embodiment. Accordingly, additional hardware and/or interrupts may not be required to process a detected OOO packet.

As discussed with reference to operation (4), an embodiment calculates and stores the next expected sequence number of each flow. To determine if a sequence of packets is monotonically increasing, logic (e.g., implemented in hardware in an embodiment) on the network adapter 230 may determine OOO packets at line rate (such as the logic 260). The calculation of the next expected sequence number may be done by an adder (not shown) and packet inspection logic 302.

In some embodiments, existing implementations of TCP network stack (e.g., stored in memory 212) may be modified to make use of the features discussed herein. In an embodiment, the TCP stack need not perform OOO checks, and may assume that packets are in-order unless notified by the network adapter 230 such as discussed with reference to operation 314. As the socket buffer (e.g., buffer(s) 238) fills up, data in consecutive memory may be copied to application space (e.g., within the memory 212 or another storage device discussed with reference to FIG. 2 or 5). Gaps in the packet series stored in the socket buffer may hold up delivery of all data to the application space, until they are filled. This behavior may be the same if OOO packets had arrived from the network 102. One difference lies in that these holes may very quickly be filled (since the packets are already in the system), the fast path continues to be taken by each processor/core, and the existence of OOO packets may not induce congestion control on the sender.

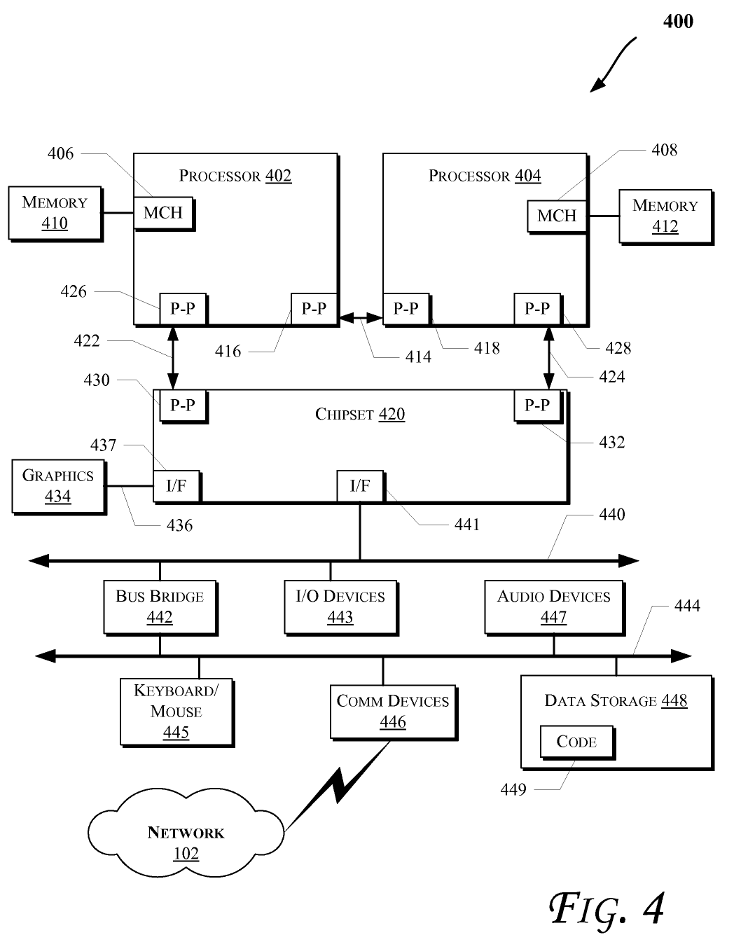

FIG. 4 illustrates a computing system 400 that is arranged in a point-to-point (PtP) configuration, according to an embodiment of the invention. In particular, FIG. 4 shows a system where processors, memory, and input/output devices are interconnected by a number of point-to-point interfaces. The operations discussed with reference to FIGS. 1-3 may be performed by one or more components of the system 400.

As illustrated in FIG. 4, the system 400 may include several processors, of which only two, processors 402 and 404 are shown for clarity. The processors 402 and 404 may each include one or more of the caches 264 and/or logic 263. The memories 410 and/or 412 may store various data such as those discussed with reference to the memory 212 of FIG. 4.

In an embodiment, the processors 402 and 404 may be one of the processors 402 discussed with reference to FIG. 4. The processors 402 and 404 may exchange data via a point-to-point (PtP) interface 414 using PtP interface circuits 416 and 418, respectively. Further, the processors 402 and 404 may include a high speed (e.g., general purpose) I/O bus channel in some embodiments of the invention to facilitate communication with various components (such as I/O device(s)). Also, the processors 402 and 404 may each exchange data with a chipset 420 via individual PtP interfaces 422 and 424 using point-to-point interface circuits 426, 428, 430, and 432. The chipset 420 may further exchange data with a graphics circuit 434 via a graphics interface 436, e.g., using a PtP interface circuit 437.

At least one embodiment of the invention may be provided within the processors 402 and 404. For example, one or more of the components discussed with reference to FIG. 2 may (such as the logic 260) be provided on the processors 402 and/or 404. Also, in one embodiment, the logic 260 may be provided on one or more of the processors 202. Other embodiments of the invention, however, may exist in other circuits, logic units, or devices within the system 400 of FIG. 4. Furthermore, other embodiments of the invention may be distributed throughout several circuits, logic units, or devices illustrated in FIG. 4.

The chipset 420 may communicate with a bus 440 using a PtP interface circuit 441. The bus 440 may communicate with one or more devices, such as a bus bridge 442 and I/O devices 443. Via a bus 444, the bus bridge 442 may communicate with other devices such as a keyboard/mouse 445, communication devices 446 (such as modems, network interface devices, or other communication devices that may communicate with the computer network 102, including for example, the network adapter 230 of FIG. 2), audio I/O device 447, and/or a data storage device 448. The data storage device 448 may store code 449 that may be executed by the processors 402 and/or 404.

In various embodiments of the invention, the operations discussed herein, e.g., with reference to FIGS. 1-4, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed herein.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a network adapter comprising a first logic to extract a sequence number and a flow identifier from a received packet;
a storage device coupled to the first logic to store a plurality of entries, wherein each entry comprises an expected sequence number and a corresponding flow identifier; and
the network adapter comprising a second logic to compare an expected sequence number corresponding to the extracted flow identifier with the extracted sequence number, wherein the second logic is to indicate, to a processor coupled to the network adapter via a chipset, that the received packet is an out-of-order packet in response to a determination that the expected sequence number and the extracted sequence number are different.

2. The apparatus of claim 1, wherein the second logic causes a next expected sequence number to be stored in the storage device in response to an indication that the expected sequence number and the extracted sequence number match.

3. The apparatus of claim 2, wherein the next expected sequence number is determined based on a combination of the extracted sequence number and a payload length of the received packet.

4. The apparatus of claim 1, wherein the expected sequence number is stored in the storage device.

5. The apparatus of claim 1, wherein the first logic comprises a processor.

6. The apparatus of claim 1, wherein the processor comprises one or more processor cores.

7. The apparatus of claim 1, wherein the storage device comprises one or more of a network adapter memory, a main system memory, or a cache.

8. The apparatus of claim 7, wherein the cache comprises one or more of a shared cache or a private cache.

9. The apparatus of claim 7, wherein the cache comprises one or more of a level 1 (L1) cache, a level 2 (L2) cache, a mid-level cache (MLC), or a last level cache (LLC).

10. A method comprising:
extracting a sequence number and a flow identifier from a received packet;
comparing an expected sequence number corresponding to the extracted flow identifier with the extracted sequence number; and
forming a packet descriptor having at least one bit to indicate that the received packet is an out-of-order packet in response to a result of the comparison that indicates the expected sequence number and the extracted sequence number are different.

11. The method of claim 10, further comprising storing the formed packet descriptor in a storage device.

12. The method of claim 10, further comprising storing a next expected sequence number in a storage device in response to an indication that the expected sequence number and the extracted sequence number match.

13. The method of claim 12, further comprising combing the extracted sequence number and a payload length of the received packet to determine the next expected sequence number.

14. The method of claim 10, further comprising storing a plurality of entries in a storage device, wherein each entry comprises an expected sequence number and a corresponding flow identifier.

15. The method of claim 14, wherein the flow identifier comprises a protocol identifier and an address.
